(19) United States
(12) Patent Application Publication
(10) Pub. No.: US 2021/0043164 A1
(43) Pub. Date: Feb. 11, 2021

(54) DISPLAY CONTROL DEVICE, DISPLAY CONTROL METHOD, AND STORAGE MEDIUM

(71) Applicant: HONDA MOTOR CO., LTD., Tokyo (JP)

(72) Inventor: Ryohei Tokuda, Wako-shi (JP)

(21) Appl. No.: 16/984,196

(22) Filed: Aug. 4, 2020

(30) Foreign Application Priority Data
Aug. 9, 2019 (JP) 2019-147351

(51) Int. Cl. G09G 5/10; B60K 35/00

(52) U.S. Cl. CPC G09G 5/10; B60K 35/00; G09G 2360/141; B60K 2370/48; G09G 2320/0653; B60K 2370/349; B60K 2370/1529; G09G 2360/144

(57) ABSTRACT

A display control device includes an illuminance acquisition unit configured to acquire ambient illuminance, and a luminance control unit configured to control luminance of an image to be displayed on a display unit on the basis of the illuminance acquired by the illuminance acquisition unit. When the illuminance acquired by the illuminance acquisition unit satisfies a predetermined condition during execution of luminance control in a first mode in which the luminance is changed at a first luminance change speed, the luminance control unit shifts to a second mode in which the luminance is changed at a second luminance change speed faster than the first luminance change speed, and returns to the first mode when a predetermined time has elapsed after shifting to the second mode.

### CROSS-REFERENCE TO RELATED APPLICATION

Priority is claimed on Japanese Patent Application No. 2019-147351, filed Aug. 9, 2019, the content of which is incorporated herein by reference.

### BACKGROUND

### Field of the Invention

The present invention relates to a display control device, a display control method, and a storage medium.

### Description of Related Art

In the related art, there is known a technology of adjusting a luminance change speed according to an amount of change in ambient brightness when an image is projected by a projector (for example, Japanese Unexamined Patent Application, First Publication No. 2018-54784).

### SUMMARY

However, since the brightness of the surroundings of a moving body such as a vehicle is likely to change according to a movement situation, there are cases where it is not possible to appropriately adjust the luminance of an image displayed on a display device in the related art.

The present invention is achieved in view of the problems described above, and one object of an aspect of the present invention is to provide a display control device, a display control method, and a storage medium, by which it is possible to perform luminance adjustment more appropriately.

In order to solve the aforementioned problems and achieve the object, the present invention adopts the following aspects.

(1) A display control device according to an aspect of the present invention includes: an illuminance acquisition unit configured to acquire ambient illuminance; and a luminance control unit configured to control luminance of an image to be displayed on a display unit on the basis of the illuminance acquired by the illuminance acquisition unit, wherein, when the illuminance acquired by the illuminance acquisition unit satisfies a predetermined condition during execution of luminance control in a first mode in which the luminance is changed at a first luminance change speed, the luminance control unit shifts to a second mode in which the luminance is changed at a second luminance change speed faster than the first luminance change speed, and returns to the first mode when a predetermined time has elapsed after shifting to the second mode.

(2) In the aspect (1), the display control device further includes a bright-dark state determination unit configured to determine an ambient bright-dark state on the basis of the illuminance acquired by the illuminance acquisition unit, wherein, during the execution of the luminance control in the first mode, when it is determined by the bright-dark state determination unit that the ambient bright-dark state is a dark state and a state in which the illuminance acquired by the illuminance acquisition unit is equal to or more than a first predetermined illuminance has continued for a first predetermined time or more, the luminance control unit may shift to the second mode.

(3) In the aspect (2), during the execution of the luminance control in the first mode, when it is determined by the bright-dark state determination unit that the ambient bright-dark state is a bright state and a state in which the illuminance acquired by the illuminance acquisition unit is equal to or less than a second predetermined illuminance has continued for a second predetermined time or more, the luminance control unit may shift to the second mode.

(4) In the aspect (2) or (3), when the bright-dark state is the bright state and a control mode is shifted to the second mode by the luminance control unit, the bright-dark state determination unit may shift the ambient bright-dark state to the dark state, and when the bright-dark state is the dark state and the control mode is shifted to the second mode by the luminance control unit, the bright-dark state determination unit may shift the ambient bright-dark state to the bright state.

(5) In the aspect (3), during the execution of the luminance control in the first mode, when the bright-dark state is the dark state and the state in which the illuminance is equal to or more than the first predetermined illuminance has continued for the first predetermined time or more or when the bright-dark state is the bright state and the state in which the illuminance is equal to or less than the second predetermined illuminance has continued for the second predetermined time or more, which is different from the first predetermined time, the luminance control unit may shift to the second mode.

(6) In any one of the aspects (2) to (5), the luminance control unit may allow a luminance change speed in the second mode when the bright-dark state is the dark state and the first mode has shifted to the second mode to be different from a luminance change speed when the bright-dark state is the bright state and the first mode has shifted to the second mode.

(7) In any one of the aspects (1) to (6), the display unit is a display unit mounted on a vehicle, and the display control device further includes a vehicle information acquisition unit configured to acquire information on the vehicle, wherein the luminance control unit may change a condition for shifting from the first mode to the second mode on the basis of the vehicle information acquired by the vehicle information acquisition unit.

(8) A display control device according to an aspect of the present invention includes: an illuminance acquisition unit configured to acquire ambient illuminance; and a luminance control unit configured to control luminance of an image to be displayed on a display unit on the basis of the illuminance acquired by the illuminance acquisition unit, wherein the luminance control unit has a first mode in which the luminance is changed at a first luminance change speed, and a second mode in which the luminance is changed at a second luminance change speed faster than the first luminance change speed when a state in which the illuminance acquired by the illuminance acquisition unit is equal to or more than a first predetermined illuminance has continued for a first predetermined time or more or a state in which the illuminance is equal to or less than a second predetermined illuminance has continued for a second predetermined time or more.

(9) A display control method according to an aspect of the present invention is implemented by a computer performing the steps of: acquiring ambient illuminance; controlling luminance of an image to be displayed on a display unit on the basis of the acquired illuminance; when the illuminance satisfies a predetermined condition during execution of luminance control in a first mode in which the luminance is changed at a first luminance change speed, shifting to a second mode in which the luminance is changed at a second luminance change speed faster than the first luminance change speed; and returning to the first mode when a predetermined time has elapsed after shifting to the second mode.

(10) A computer readable non-transitory storing medium according to an aspect of the present invention stores a program causing a computer to perform the steps of: acquiring ambient illuminance; controlling luminance of an image to be displayed on a display unit on the basis of the acquired illuminance; when the illuminance satisfies a predetermined condition during execution of luminance control in a first mode in which the luminance is changed at a first luminance change speed, shifting to a second mode in which the luminance is changed at a second luminance change speed faster than the first luminance change speed; and returning to the first mode when a predetermined time has elapsed after shifting to the second mode.

According to the aspects of (1) to (10), it is possible to perform luminance adjustment more appropriately.

### BRIEF DESCRIPTION OF THE DRAWINGS

FIG. 1 is a schematic diagram of a vehicle provided with a display control device according to an embodiment.

FIG. 2 is a configuration diagram of the display control device according to an embodiment.

FIG. 3 is a diagram illustrating an example of installation positions of illuminance sensors and illuminance detection methods according to an embodiment.

FIG. 4 is a flowchart illustrating an example of the flow of a process of a first control pattern.

FIG. 5 is a flowchart illustrating an example of the flow of a mode change determination process related to the first control pattern.

FIG. 6 is a diagram for explaining a relation between a bright-dark state and a luminance change speed mode according to an embodiment.

FIG. 7 is a diagram for explaining an example of a relation between a first predetermined time and a second predetermined time.

FIG. 8 is a flowchart illustrating an example of the flow of a mode change determination process related to a second control pattern.

### DESCRIPTION OF EMBODIMENTS

Hereinafter, an embodiment of a display control device, a display control method, and a storage medium of the present invention will be described with reference to the drawings.

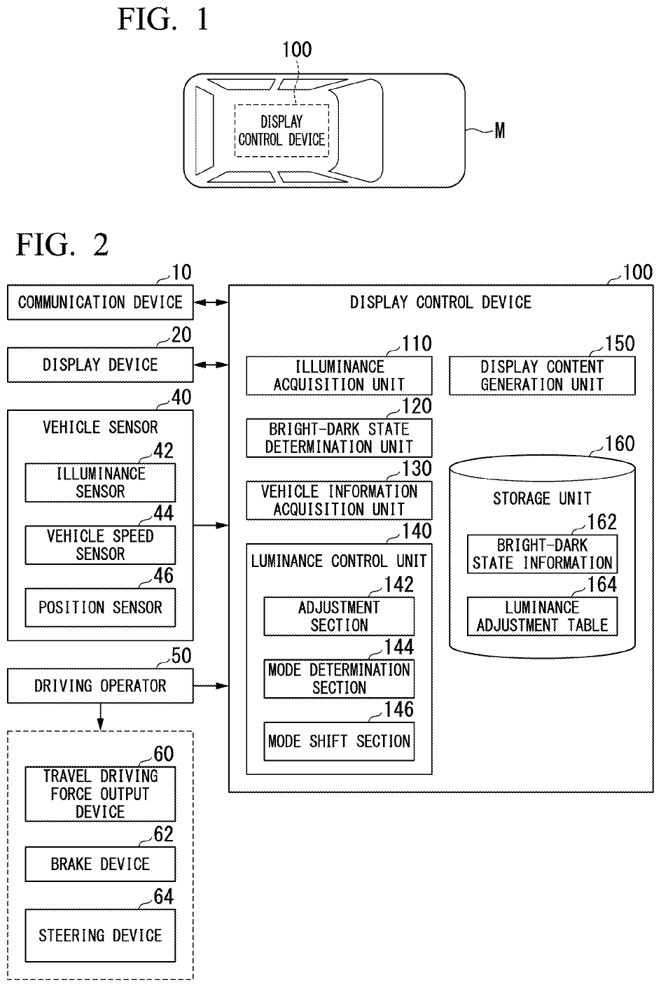

FIG. 1 is a schematic diagram of a vehicle M provided with a display control device 100 according to an embodiment. The vehicle M is a vehicle with two wheels, three wheels, four wheels and the like, for example, and its driving source is an internal combustion engine such as a diesel engine and a gasoline engine, an electric motor, or a combination thereof. The electric motor operates by using power generated by a generator connected to the internal combustion engine or power discharged from a secondary cell or a fuel cell. The display control device 100 controls a display unit mounted on the vehicle M. The display control device 100 may acquire information from other in-vehicle devices mounted on the vehicle M, and control the display unit on the basis of the acquired information.

FIG. 2 is a configuration diagram of the display control device 100 according to an embodiment. FIG. 2 illustrates the display control device 100, and a communication device 10, a display device (an example of the display unit) 20, a vehicle sensor 40, a driving operator 50, a travel driving force output device 60, a brake device 62, and a steering device 64, which are an example of in-vehicle devices other than the display control device 100 mounted on the vehicle M.

The communication device 10 communicates with other vehicles present around the vehicle M, external devices, and a terminal device (for example, a smart phone or a tablet terminal) owned by an occupant of the vehicle M, by using, for example, a cellular network, a Wi-Fi network, Bluetooth (registered trademark), a dedicated short range communication (DSRC), and the like.

The display device 20 is, for example, a liquid crystal display (LCD), an organic electroluminescence (EL) display device, and the like. The display device 20 may be a touch panel provided with a reception unit that receives the operation content of the occupant. One or more display devices 20 are provided at arbitrary positions in a vehicle interior. For example, the display device 20 is provided in the vicinity of the front of a driver's seat on an instrument panel in the vehicle M, and is installed at a position where the occupant can visually recognize the display device 20 through a gap in a steering wheel or through the steering wheel (hereinafter, the display device 20 installed at the aforementioned position is referred to as a meter display unit). The display device 20 may be installed in the vicinity of the center of the instrument panel (hereinafter, the display device installed at the aforementioned position is referred to as a center display unit). The display device 20 may be a head-up display (HUD) device.

The HUD device is a device that allows an image (including a still image, a moving image, and the like) to be superimposed on a landscape and to be visually recognized, and is, for example, a device that allows a viewer to visually recognize a virtual image by projecting light including an image on a front windshield or a combiner of the vehicle M. The viewer is, for example, a driver, but may be an occupant other than the driver. The display device 20 may be an indicator such as a lamp that indicates the state or situation of the vehicle M.

The display device 20 displays images including, for example, the speed of the vehicle M, an engine speed, a remaining fuel amount, radiator water temperature, a travel distance, and other information. These images are displayed on the meter display unit, for example. The display device 20 may display content such as an image of a route to a destination set by a navigation device (not illustrated) mounted on the vehicle M, a television program received by the communication device 10, downloaded images, and the like. These images are displayed on the center display unit, for example. The display device 20 controls the luminance of an image to be displayed on the basis of control information from the display control device 100.

The display device 20 includes an electronic control unit (ECU) that controls each component in the device. The ECU acquires current luminance information for an image to be displayed and information (for example, a control mode) on mode information correlated with a luminance change speed to be described below, and outputs the acquired information to the display control device 100. The ECU displays images on the basis of the control information from the display control device 100.

The vehicle sensor 40 is a detection unit that acquires various types of information on the surrounding environment of the vehicle M and the position, behavior and the like of the vehicle M. The vehicle sensor 40 includes, for example, illuminance sensors 42, a vehicle speed sensor 44, and a position sensor 46.

The illuminance sensor 42 detects ambient illuminance The periphery includes, for example, at least one of the periphery of the display device 20, the periphery of a user (for example, an occupant of a vehicle), and the periphery of the vehicle M. One or more illuminance sensors 42 are provided at arbitrary positions on the vehicle M.

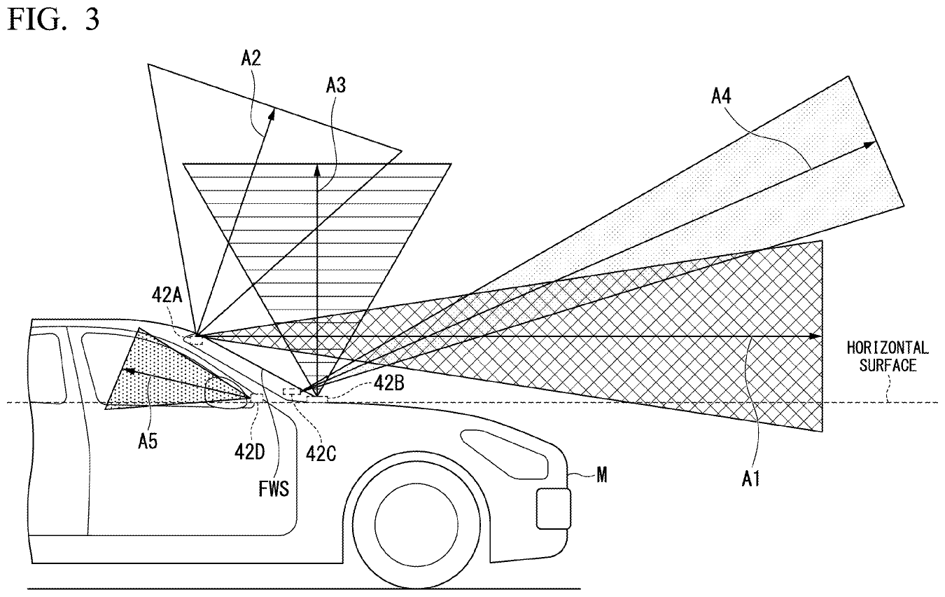

FIG. 3 is a diagram illustrating an example of installation positions of the illuminance sensors 42 and illuminance detection methods according to an embodiment. In the example of FIG. 3, four illuminance sensors 42A to 42D are illustrated as an example of the illuminance sensors 42 in a schematic view of the front portion of the vehicle M. The illuminance sensor 42A is installed, for example, on the rear surface of a room mirror in the vehicle interior or an upper portion of the front windshield. The illuminance sensor 42B is installed, for example, on the instrument panel in the vehicle interior. The illuminance sensor 42C is installed, for example, on the vehicle front direction side of the HUD device. The illuminance sensor 42C may be embedded in the HUD device. The illuminance sensor 42D is installed, for example, in the vicinity of the meter display unit or the center display unit (for example, a position within a predetermined distance from the meter display unit or the center display unit). The illuminance sensor 42D may be embedded in the meter display unit or the center display unit

The illuminance sensor 42A detects, for example, illuminance in one or both of the front direction A1 and the front diagonal upward direction A2 of the vehicle M from the installation position. The illuminance sensor 42B detects, for example, illuminance in the upward direction A3 of the vehicle M from the installation position. The illuminance sensor 42C detects, for example, illuminance in the front diagonal upward direction (direction closer to a horizontal surface than the direction A2) A4 of the vehicle M from the installation position. The illuminance sensors 42A to 42C detect illuminance in the periphery (for example, in front) of the vehicle M or in the vehicle interior by light transmitted through the front windshield FWS. The illuminance sensor 42D detects, for example, illuminance in the rear direction A5 of the vehicle M from the installation position. The illuminance sensor 42D detects, for example, illuminance in the vehicle interior (in other words, vicinity of the occupant or vicinity of the display device 20).

The illuminance sensors 42 may detect whether an external light of the vehicle M is turned on or off, or determine the strength of a wiper. The number, installation positions, and illuminance detection directions of the illuminance sensors 42 are not limited thereto, and for example, an illuminance sensor for detecting the side or rear of the vehicle M may be provided. The illuminance sensors 42 continuously detect illuminance at a predetermined timing and output detected results to the display control device 100.

Returning back to FIG. 2, the vehicle speed sensor 44 detects the speed of the vehicle M. The vehicle speed sensor 44 may detect, for example, the speed on the basis of a speedometer mounted on the vehicle M, or derive the speed on the basis of a travel distance or a travel time based on the position of the vehicle M obtained from the position sensor 46. The position sensor 46 acquires the position of the vehicle M. The position sensor 46 includes, for example, a global navigation satellite system (GNSS) receiver. The GNSS receiver identifies the position of the vehicle M on the basis of a signal received from a GNSS satellite. The position of the vehicle M may be specified or supplemented by an inertial navigation system (INS) using the output of another sensor included in the vehicle sensor 40, for example.

The vehicle sensor 40 may include, for example, an acceleration sensor that detects an acceleration of the vehicle M, a yaw rate sensor that detects an angular velocity around a vertical axis, a direction sensor that detects the direction of the vehicle M, and the like. The vehicle sensor 40 continuously detects data at a predetermined timing and outputs detected results to the display control device 100.

The driving operator 50 includes, for example, an accelerator pedal, a brake pedal, a shift lever, steering wheel, a deformed steer, a joy stick, and other operators. The driving operator 50 is provided with a sensor for detecting an operation amount or the presence or absence of an operation, and its detection result is output to some or all of the travel driving force output device 60, the brake device 62, and the steering device 64 of the vehicle M. The occupant drives the vehicle M by operating the driving operator 50.

The travel driving force output device 60 outputs a travel driving force (torque) for driving the vehicle M to driving wheels. The travel driving force output device 60 includes, for example, a combination of an internal combustion engine, an electric motor, a transmission and the like, and an ECU for controlling them. The ECU controls the aforementioned configuration according to the information input from the driving operator 50. The brake device 62 includes, for example, a brake caliper, a cylinder for transferring hydraulic pressure to the brake caliper, an electric motor for generating the hydraulic pressure in the cylinder, and a brake ECU. The brake ECU controls the electric motor according to the information input from the driving operator 50, thereby allowing a brake torque corresponding to a brake operation to be output to each wheel. The steering device 64 includes, for example, a steering ECU and an electric motor. The electric motor, for example, changes a direction of a steering wheel by allowing a force to act on a rack and pinion mechanism. The steering ECU drives the electric motor according to the information input from the driving operator 50, thereby changing the direction of the steering wheel. The information received from the driving operator 50 is output to the display control device 100.

The display control device 100 includes, for example, an illuminance acquisition unit 110, a bright-dark state determination unit 120, a vehicle information acquisition unit 130, a luminance control unit 140, a display content generation unit 150, and a storage unit 160. Each component of the display control device 100, except for storage unit 160, is implemented by, for example, a hardware processor such as a central processing unit (CPU) that executes a program (software). Some or all of these components may be implemented by hardware (a circuit unit: including circuitry) such as a large scale integration (LSI), an application specific integrated circuit (ASIC), a field-programmable gate array (FPGA), and a graphics processing unit (GPU), or may be implemented by software and hardware in cooperation. The program may be stored in advance in a storage device (storage device including a non-transitory storage medium) such as an HDD and a flash memory of the display control device 100, or may be installed in the HDD and the flash memory of the display control device 100 when a detachable storage medium (non-transitory storage medium) storing the program, such as a DVD and a CD-ROM, is mounted on a drive device.

The storage unit 160 is implemented by the aforementioned various storage devices, or an electrically erasable programmable read only memory (EEPROM), a read only memory (ROM), a random access memory (RAM), and the like. The storage unit 160 stores, for example, bright-dark state information 162, a luminance adjustment table 164, a program, and other various types of information. The bright-dark state information 162 is an index value for identifying a bright-dark state correlated with the magnitude of illuminance The bright-dark state includes, for example, a bright state and a dark state. The luminance adjustment table 164 is information in which illuminance is correlated with target luminance when an image is displayed on the display device 20. The target luminance is a target value of the luminance at which it is predicted that a user will easily recognize an image displayed on the display device 20 in ambient illuminance, for example. The luminance adjustment table 164 is acquired by, for example, an external device and the like via the communication device 10.

The illuminance acquisition unit 110 acquires the ambient illuminance from the illuminance sensor 42. For example, when a plurality of illuminance sensors 42 are installed in the vehicle M, the illuminance acquisition unit 110 acquires a final illuminance value on the basis of illuminance obtained from the plurality of illuminance sensors 42. In such a case, the illuminance acquisition unit 110 may set, as the ambient illuminance, a maximum value or an average value of the illuminance obtained from the respective illuminance sensors 42, or may calculate the ambient illuminance by assigning a weight corresponding to the type of the illuminance sensors and directions in which the illuminance has been detected. The illuminance acquisition unit 110 may preferentially acquire the illuminance from predetermined illuminance sensors (for example, the illuminance sensors 42A and 42B) among the plurality of illuminance sensors 42, or acquire the illuminance from another illuminance sensor (for example, the illuminance sensor 42D) when the illuminance sensors detect no illuminance due to an influence such as a failure or has detected an abnormal value.

The bright-dark state determination unit 120 determines an ambient bright-dark state on the basis of the ambient illuminance acquired by the illuminance acquisition unit 110. For example, when the illuminance is equal to or more than a threshold, the bright-dark state determination unit 120 determines that the bright-dark state is a bright state, and when the illuminance is smaller than the threshold, the bright-dark state determination unit 120 determines that the bright-dark state is a dark state. When the state in which the illuminance is equal to or more than the threshold has continued for a predetermined time or more, the bright-dark state determination unit 120 may determine that the bright-dark state is the bright state, and when the state in which the illuminance is smaller than the threshold has continued for the predetermined time or more, the bright-dark state determination unit 120 may determine that the bright-dark state is the dark state. In the state in which the bright-dark state is the bright state, when a control mode by the luminance control unit 140 is shifted from a current mode to another mode, the bright-dark state determination unit 120 may transition the bright-dark state to the dark state. In the state in which the bright-dark state is the dark state, when the control mode is shifted from the current mode to another mode, the bright-dark state determination unit 120 may transition the bright-dark state to the bright state. The bright-dark state determined by the bright-dark state determination unit 120 is stored in the storage unit 160 as the bright-dark state information 162.

The vehicle information acquisition unit 130 acquires information (vehicle information) on the vehicle M from the in-vehicle devices. The vehicle information includes, for example, information on the speed of the vehicle M obtained from the vehicle speed sensor 44, the position of the vehicle M obtained from the position sensor 46, and the behavior of the vehicle M obtained from the driving operator 50. The luminance control unit 140 controls the luminance of an image to be displayed on the display device 20. For example, the luminance control unit 140 acquires information such as the target luminance and the control mode on the basis of the bright-dark information and the illuminance, and outputs control information for controlling luminance on the basis of the acquired information to the display device 20. The control mode includes, for example, a luminance change speed mode. The luminance change speed mode includes a first mode (normal adjustment mode) in which the luminance of the image to be displayed on the display device 20 is changed at a first luminance change speed, and a second mode (high-speed adjustment mode) in which the luminance of the image is changed at a second luminance change speed faster than the first luminance change speed. The second mode is executed when a predetermined condition is satisfied during the execution of the first mode.

The luminance control unit 140 includes, for example, an adjustment section 142, a mode determination section 144, and a mode shift section 146. The adjustment section 142 refers to the illuminance of the luminance adjustment table 164 stored in the storage unit 160, on the basis of the ambient illuminance acquired by the illuminance acquisition unit 110, and acquires target luminance correlated with illuminance that is the same as or closest to the referred illuminance. On the basis of a difference value between the current luminance acquired from the display device 20 and the target luminance, the luminance control unit 140 may derive an adjustment value for changing the current luminance to the target luminance On the basis of the target luminance or the adjustment value, the adjustment section 142 generates control information for linearly changing the luminance of the display device 20 to the target luminance at a predetermined change speed, and outputs the generated control information to the display device 20. The predetermined change speed is a speed corresponding to a luminance change mode to be described below. The adjustment section 142 may output the generated control information to the display device 20 together with control information generated by the mode shift section 146.

The mode determination section 144 determines on the basis of the ambient illuminance acquired by the illuminance acquisition unit 110 whether it is necessary to change the luminance change speed mode included in the current mode information acquired from the display device 20. The luminance change speed mode includes the first mode (normal adjustment mode) in which the luminance of the image to be displayed on the display device 20 is changed at the first luminance change speed, and the second mode (high-speed adjustment mode) in which the luminance of the image is changed at the second luminance change speed faster than the first luminance change speed. On the basis of the vehicle information acquired by the vehicle information acquisition unit 130, the mode determination section 144 may determine whether to change the luminance change speed mode, or may change the luminance change speed.

When the mode determination section 144 determines that it is necessary to change the luminance change speed mode, the mode shift section 146 generates control information that allows the display device 20 to change the luminance change speed mode, and outputs the generated control information to the display device 20. On the basis of an elapsed time after shifting to a different mode, the mode shift section 146 may generate control information for shifting the luminance change speed mode, and output the generated control information to the display device 20. The mode shift section 146 may generate control information for changing the luminance change speed on the basis of the determination content of the mode determination section 144, and output the generated control information to the display device 20. The mode shift section 146 may output the generated control information to the display device 20 together with the control information generated by the adjustment section 142.

The display content generation unit 150 generates display content included in the image to be displayed on the display device 20. The display content includes, for example, information acquired from each of the communication device 10, the display device 20, the vehicle sensor 40, and the driving operator 50, and information generated on the basis of the acquired information. The display content may include information acquired from a navigation device (not illustrated), an air conditioning device (not illustrated), and a DVD player (not illustrated), which are mounted on the vehicle, and other in-vehicle devices. The display content may include information on a display mode such as which information is displayed on which display device 20 and at which position on the screen thereof. The display content generation unit 150 generates images and control information corresponding to the generated display content and outputs the generated images and control information to the display device 20.

### Details of Functions of Display Control Device

Next, details of the functions of the display control device 100 will be described. Hereinafter, luminance control of the display control performed in the display control device 100 will be mainly described for each of some control patterns.

### First Control Pattern

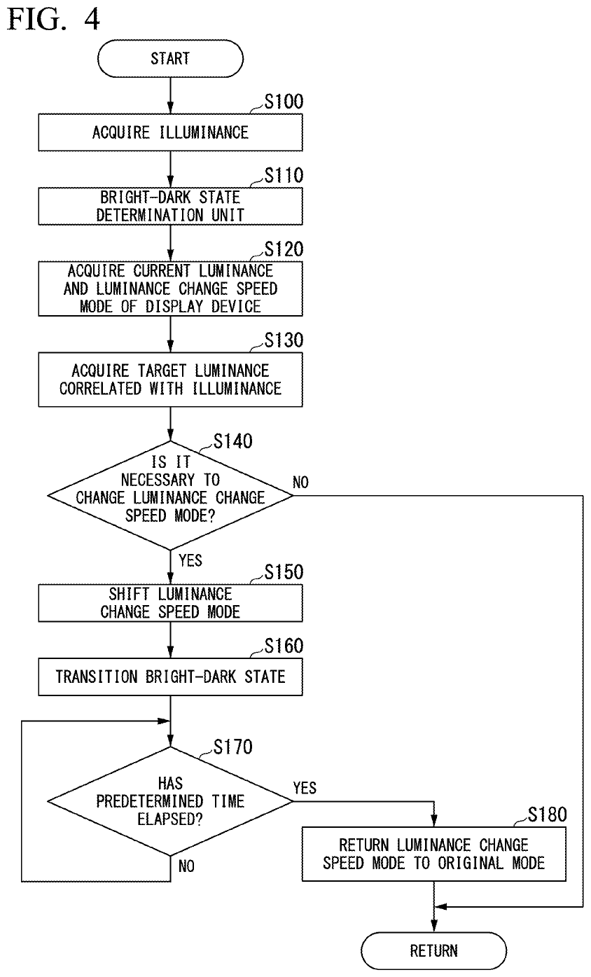

FIG. 4 is a flowchart illustrating an example of the flow of a process of the first control pattern. The process of FIG. 4 is repeatedly performed at predetermined timings As a normal state (initial state) of the display control device 100, the luminance change speed mode is assumed to be the first mode. In the example of FIG. 4, the illuminance acquisition unit 110 acquires the ambient illuminance from the illuminance sensors 42 (step S100). Next, the bright-dark state determination unit 120 determines the ambient bright-dark state on the basis of the acquired illuminance (step S110). In the process of step S110, the bright-dark state determination unit 120 allows the storage unit 160 to store the determined bright-dark information.

Next, the adjustment section 142 of the luminance control unit 140 acquires the current luminance and the luminance change speed mode of the display device 20 (step S120). Next, the adjustment section 142 refers to the illuminance of the luminance adjustment table 164 stored in the storage unit 160 on the basis of the acquired illuminance, and acquires the target luminance correlated with the illuminance that is the same as or closest to the referred illuminance (step S130). Next, the mode determination section 144 determines on the basis of the bright-dark state and the ambient illuminance whether it is necessary to change the current luminance change speed mode acquired from the display device 20 (step S140). Details of the mode change determination process in step S140 will be described below.

When it is determined to change the luminance change speed mode, the mode shift section 146 generates control information for shifting the luminance change speed mode from the first mode to the second mode, and outputs the generated control information to the display device 20, thereby shifting the luminance change speed mode (step S150). Next, the bright-dark state determination unit 120 transitions the bright-dark state from the current state (one state) to another state (step S160). Next, the mode shift section 146 determines whether a predetermined time has elapsed after shifting the luminance change speed mode (step S170). When the predetermined time has not elapsed, the mode shift section 146 waits until the predetermined time elapses, and when the predetermined time has elapsed, the mode shift section 146 performs a process of returning the luminance change speed mode from the second mode to the original first mode (step S180). With this, the process of the present flowchart ends. In the process of step S140, when it is determined not to change the luminance change speed mode, the process of the present flowchart ends. The order of the processes of steps S100, S110, and S120 illustrated in FIG. 4 is not limited thereto. Regarding the process of step S130, as long as it is after step S110, the context of steps S120 and S130 may be different from the example of FIG. 4.

### Mode Change Determination Process

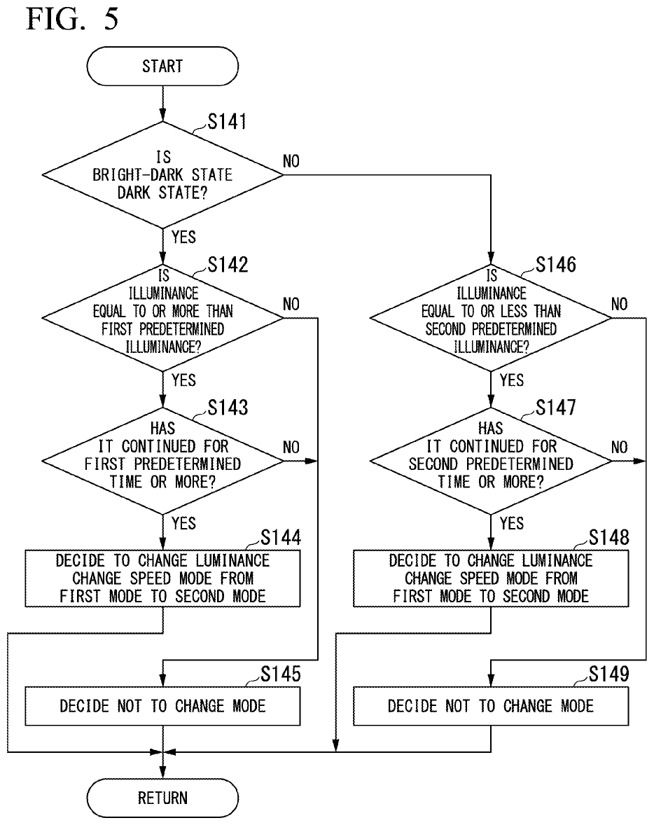

Next, details of the process (mode change determination process) of step S140 will be described. FIG. 5 is a flowchart illustrating an example of the flow of the mode change determination process related to the first control pattern. In the example of FIG. 5, the mode determination section 144 determines whether the bright-dark state determined by the bright-dark state determination unit 120 is a dark state (step S141).

When the bright-dark state is the dark state, the mode determination section 144 determines whether the illuminance acquired by the illuminance acquisition unit 110 is equal to or more than first predetermined illuminance (step S142). When it is determined that the illuminance is equal to or more than the first predetermined illuminance, the mode determination section 144 determines whether the state in which the illuminance is equal to or more than the first predetermined illuminance has continued for a first predetermined time or more (step S143). When it is determined that the state has continued for the first predetermined time or more, the mode determination section 144 decides to change the luminance change speed mode from the first mode to the second mode (step S144). When it is determined in the process of step S142 that the illuminance is not equal to or more than the first predetermined illuminance or when it is determined in the process of step S143 that the state has not continued for the first predetermined time or more, the mode determination section 144 decides not to change the luminance change speed mode (step S145).

When it is determined in the process of step S141 that the bright-dark state is not the dark state, the bright-dark state is a bright state. Therefore, the mode determination section 144 determines whether the illuminance is equal to or less than second predetermined illuminance in the state in which the bright-dark state is the bright state (step S146). The second predetermined illuminance is illuminance smaller (darker) than the first predetermined illuminance When it is determined that the illuminance is equal to or less than the second predetermined illuminance, the mode determination section 144 determines whether the state in which the illuminance is equal to or less than the second predetermined illuminance has continued for a second predetermined time or more (step S147). When it is determined that the state has continued for the second predetermined time or more, the mode determination section 144 decides to change the luminance change speed mode from the first mode to the second mode (step S148).

When it is determined in the process of step S146 that the illuminance is not equal to or less than the second predetermined illuminance or when it is determined in the process of step S147 that the state has not continued for the second predetermined time or more, the mode determination section 144 decides not to change the luminance change speed mode (step S149). With this, the process of the present flowchart ends.

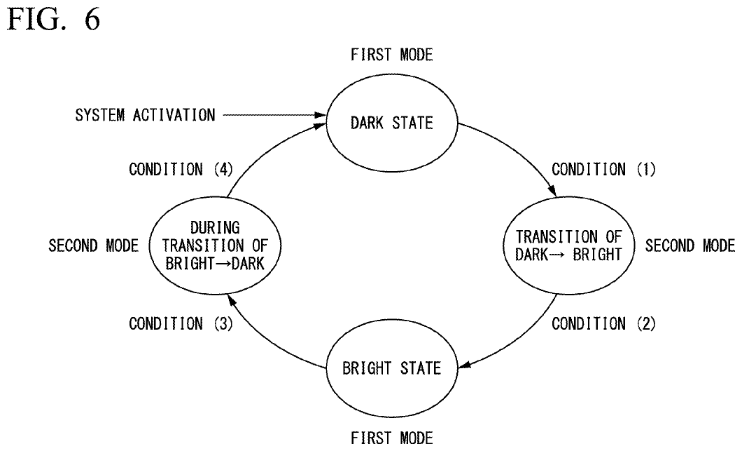

Next, a relation between the bright-dark state and the luminance change speed mode of an embodiment will be described with reference to the drawing. FIG. 6 is a diagram for explaining the relation between the bright-dark state and the luminance change speed mode according to an embodiment. In the example of FIG. 6, for example, when a vehicle system including the display device 20 and the display control device 100 is activated, it is assumed that the bright-dark state determination unit 120 of the display control device 100 sets the bright-dark state as the dark state as an initial state and sets the luminance change speed mode as the first mode (normal adjustment mode). When the conditions (1) to (4) illustrated in FIG. 6 are satisfied, the display control device 100 shifts the luminance change speed mode in the display device 20.

For example, when the bright-dark state information 162 stored in the storage unit 160 indicates the dark state, the ambient illuminance becomes large (bright) (“dark→bright transition of FIG. 6”), and the condition (1) is satisfied, the mode shift section 146 shifts the luminance change speed mode from the first mode to the second mode. The condition (1) is, for example, that the illuminance acquired by the illuminance acquisition unit 110 is equal to or more than the first predetermined illuminance and the state in which the illuminance is equal to or more than the first predetermined illuminance is continued for the first predetermined time or more. When the luminance change speed mode has shifted to the second mode, luminance adjustment is performed with a faster response than in the first mode. That is, the luminance of an image to be displayed is adjusted to the target luminance earlier than in the execution of the first mode. When the luminance change speed mode has shifted to the second mode, the bright-dark state determination unit 120 transitions the bright-dark state from the dark state to the bright state. When the condition (1) is not satisfied, the luminance adjustment in the first mode is continued.

When the condition (2) is satisfied in the second mode, the mode shift section 146 shifts the luminance change speed mode from the second mode to the first mode. The condition (2) is, for example, that a predetermined time (first high-speed response duration time DT1) elapses after the second mode is executed. In such a case, the mode shift section 146 performs a process of returning to the first mode after the first high-speed response duration time DT1 elapses, regardless of the ambient illuminance.

When the bright-dark state information 162 indicates the bright state, the ambient illuminance becomes small (dark) (“brighter dark transition of FIG. 6”), and the condition (3) is satisfied, the mode shift section 146 shifts the luminance change speed mode from the first mode to the second mode. The condition (3) is, for example, that the illuminance acquired by the illuminance acquisition unit 110 is equal to or less than the second predetermined illuminance and the state in which the illuminance is equal to or less than the second predetermined illuminance is continued for the second predetermined time or more. When the luminance change speed mode has shifted to the second mode, luminance adjustment is performed with a faster response than in the first mode. When the luminance change speed mode has shifted to the second mode, the bright-dark state determination unit 120 transitions the bright-dark state from the bright state to the dark state. When the condition (3) is not satisfied, the luminance adjustment in the first mode is continued.

When the condition (4) is satisfied in the second mode, the mode shift section 146 shifts the luminance change speed mode from the second mode to the first mode. The condition (4) is, for example, that a predetermined time (second high-speed response duration time DT2) elapses after the second mode is executed. In such a case, the mode shift section 146 performs a process of returning to the first mode after the second high-speed response duration time DT2 elapses, regardless of the ambient illuminance. When the luminance change speed mode has returned to the first mode, it is determined by the bright-dark state determination unit 120 that the bright-dark state information 162 stored in the storage unit 160 indicates the dark state.

By performing the aforementioned luminance control, it is possible to adjust the luminance of a display image more appropriately in correlation with a change in the ambient illuminance. By setting the first predetermined time and the second predetermined time in the mode determination, it is possible to suppress frequent switching of the luminance change speed mode in a situation where bright and dark are switched instantaneously or continuously (for example, when passing under a viaduct or when traveling on a road at night where street lamps are positioned some distance away).

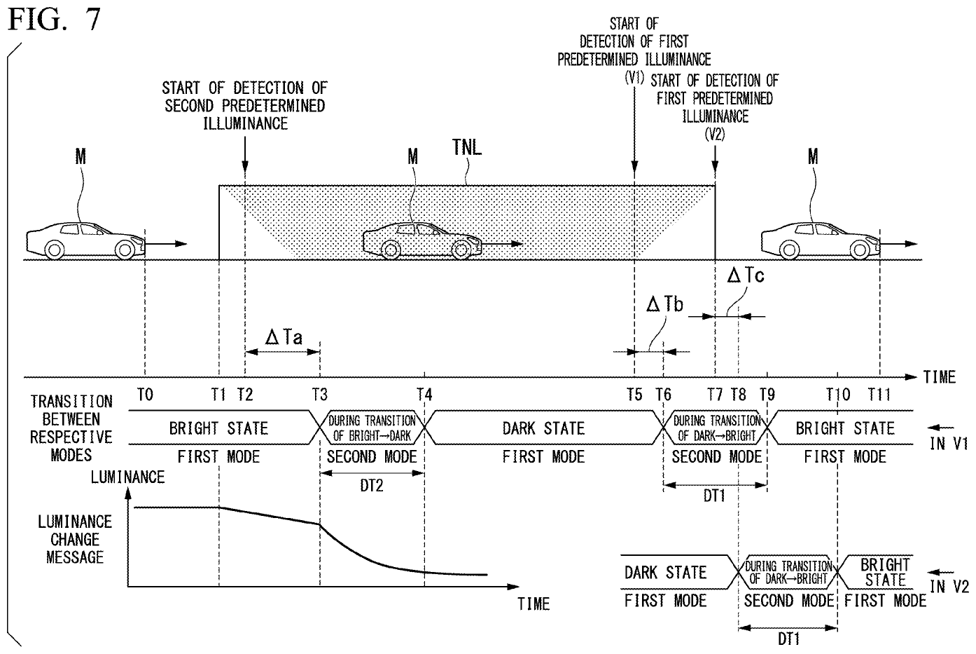

In the aforementioned example, the second predetermined time is preferably set to be equal to or less than the first predetermined time, and more preferably set as a time shorter than the first predetermined time. FIG. 7 is a diagram for explaining an example of a relation between the first predetermined time and the second predetermined time. The example of FIG. 7 illustrates a scene where the vehicle M passes through a tunnel TNL during the day (daytime). Times T0 to T11 represent times when the traveling vehicle M has reached points, and it is assumed that respective times have a relation of “T0<T1<T2<T3<T4<T5<T6<T7<T8<T9<T10<T11”. FIG. 7 also illustrates a transition between respective modes and a part of luminance change messages with the elapse of time.

At the time T0, the bright-dark state of the vehicle M is the bright state. In the bright state, luminance is changed based on the ambient illuminance in the first mode (normal adjustment mode). For example, after the time T1 when the vehicle M has reached in the vicinity of an entrance of the tunnel TNL, since the ambient illuminance becomes darker, the display control device 100 changes the luminance in the first mode. At the time T2, it is assumed that the ambient illuminance of the vehicle M is equal to or less than the second predetermined illuminance (start of detection of the second predetermined illuminance). In such a case, when the ambient illuminance is equal to or less than the second predetermined illuminance until the time T3 after time ΔTa from the time T2, the mode determination section 144 shifts from luminance control in the first mode to luminance control with a faster response in the second mode. In such a case, the luminance is controlled such that it becomes darker with a larger change than in the first mode. The changing method may be nonlinear as in the example of FIG. 7, or linear. At the time T4 when the second high-speed response duration time DT2 has elapsed after the luminance control in the second mode is performed, the mode determination section 144 returns to the first mode and performs luminance control with the normal response. The transition from the bright state to the dark state is performed from the time T3 to the time T4, and the bright-dark state of the vehicle M after the time T4 becomes the dark state.

Here, when the illuminance sensor 42 mounted on the vehicle M detects illuminance in the front direction (hereinafter, this case is referred to as a first scene V1), it is assumed that the illuminance around the side in front of the vehicle M becomes bright at the time T5 when the vehicle M has reached the vicinity of an exit of the tunnel TNL, and the ambient illuminance is equal to or more than the first predetermined illuminance (start of detection of the first predetermined illuminance). In such a case, when the ambient illuminance is equal to or more than the first predetermined illuminance until the time T6 after time ΔTb elapses from the time T5, the mode determination section 144 shifts from luminance control in the first mode to luminance control with a faster response in the second mode. In such a case, the luminance is controlled such that it becomes brighter with a larger change than in the first mode. At the time T9 when the first high-speed response duration time DT1 has elapsed after the luminance control in the second mode is performed, the mode determination section 144 returns to the first mode and performs luminance control with the normal response. That is, in the first scene V1, the transition from the dark state to the bright state in the second mode is performed from the time T6 to the time T9, and the bright-dark state of the vehicle M after the time T9 becomes the bright state.

When the illuminance sensor 42 does not detect the illuminance in the front direction as in the first scene V1, but detects illuminance in the upward direction of the vehicle M (hereinafter, this case is referred to as a second scene V2), the ambient illuminance does not become equal to or more than the first predetermined illuminance at the time T5 and becomes equal to or more than the first predetermined illuminance at the time T7 when the vehicle M has reached the exit of the tunnel TNL (start of detection of the first predetermined illuminance). In such a case, when the ambient illuminance is equal to or more than the first predetermined illuminance until the time T8 after time ΔTc elapses from the time T7, the mode determination section 144 shifts from luminance control with the normal response in the first mode to luminance control with a faster response in the second mode. At the time T10 when the first high-speed response duration time DT1 has elapsed after the luminance control in the second mode is performed, the mode determination section 144 returns to the first mode and performs luminance control with the normal response. That is, in the second scene V2, the transition from the dark state to the bright state in the second mode is performed from the time T8 to the time T10, and the bright-dark state of the vehicle M after the time T10 becomes the bright state. In both the first scene V1 and the second scene V2, at the time T11, the bright-dark state of the vehicle M becomes the bright state. The aforementioned time Ta is an example of the second predetermined time and the times Tb and Tc are an example of the first predetermined time.

As described above, when the vehicle M travels on a road such as the tunnel TNL, the ambient illuminance of the vehicle M greatly differs in the vicinity of the entrance and exist of the tunnel. In such a case, when the illuminance is switched from a dark situation to a bright situation, the degree of reduction in the visual recognition of an image is greater due to the influence of glare and the like than when the illuminance is switched from the bright dark situation to the dark situation. Therefore, in the embodiment, the first predetermined time and the second predetermined time are made different. More specifically, by setting the first predetermined time (times ΔTb and ΔTc) to be shorter than the second predetermined time (time ΔTa), it is possible to improve the visual recognition of an image when the dark situation changes to the bright situation.

### Second Control Pattern

Next, luminance control in the second control pattern will be described. The second control pattern is different in that, in addition to the luminance control in the first control pattern, vehicle information is acquired and a mode change is determined. Consequently, a mode change determination process will be mainly described below and a description of the same processes as the first control pattern will be omitted.

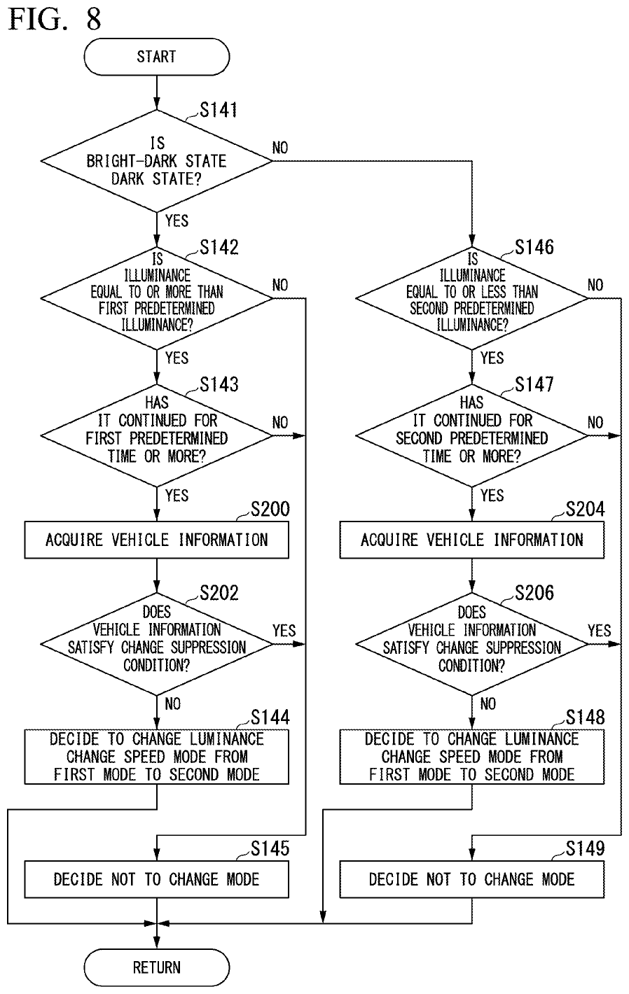

FIG. 8 is a flowchart illustrating an example of the flow of the mode change determination process related to the second control pattern. The example of FIG. 8 is different in that processes of steps S200, S202, S204, and S206 are added in addition to steps S141 to S149 of the mode change determination process related to the first control pattern illustrated in FIG. 5 described above. Consequently, the processes of steps S200, S202, S204, and S206 will be mainly described below.

When it is determined in the process of step S143 that the state in which the illuminance is equal to or more than the first predetermined illuminance has continued for the first predetermined time or more, the mode determination section 144 acquires vehicle information (step S200) and determines whether the acquired vehicle information satisfies a change suppression condition (step S202). The change suppression condition includes, for example, that the future travel route of the vehicle M is a predetermined route on the basis of the position information of the vehicle M. The predetermined route is, for example, a route such as a mountain road where a curved road with a curvature equal to or more than a predetermined value is continued for a predetermined distance or more, a route where illuminance is predicted to change frequently due to a short distance tunnel or trees around or a road when traveling along a mountain road or a forest, or a route where the amount of change in the relative position of the sun with respect to the vehicle M or the incident direction of the sunlight becomes equal to or more than a predetermined amount due to a curved road and the like. The change suppression condition may include that an instruction for suppressing a change is received from the occupant of the vehicle M. The change suppression condition may include that the operation content of the driving operator 50 included in the vehicle information (the amount of change in the steering angle of the steering wheel, the steeping amount of the acceleration pedal or the brake pedal, the speed of the vehicle M, and the like is equal to or more than a predetermined amount (that is, the vehicle M is performing a predetermined behavior)).

When it is determined that the vehicle information satisfies the change suppression condition, the mode determination section 144 decides not to change the mode (step S145). When it is determined that the vehicle information does not satisfy the change suppression condition, the mode determination section 144 decides to change the luminance change speed mode from the first mode to the second mode (step S144).

When it is determined in the process of step S147 that the state in which the illuminance is equal to or less than the second predetermined illuminance has continued for the second predetermined time or more, the mode determination section 144 acquires vehicle information (step S204) and determines whether the acquired vehicle information satisfies the change suppression condition (step S206). When it is determined that the vehicle information satisfies the change suppression condition, the mode determination section 144 decides not to change the mode (step S149). When it is determined that the vehicle information does not satisfy the change suppression condition, the mode determination section 144 decides to change the luminance change speed mode from the first mode to the second mode (step S148). With this, the process of the present flowchart ends.

In the process of FIG. 8, when the vehicle information satisfies the change suppression condition, the mode change is not performed, but instead of this, the mode determination section 144 performs a change to the second mode, but may allow the second luminance change speed in the second mode to be different from the second luminance change speed when the vehicle information does not satisfy the change suppression condition. In such a case, the mode determination section 144 may set the second luminance change speed when the vehicle information satisfies the change suppression condition to be slower than the luminance change speed when the vehicle information does not satisfy the change suppression condition. The mode determination section 144 may allow the second luminance change speed in the second mode when the first mode has shifted to the second mode in the state in which the bright-dark state is the dark state to be different from the second luminance change speed when the first mode has shifted to the second mode in the state in which the bright-dark state is the bright state.

According to the luminance control in the second control pattern described above, by determining the mode change on the basis of the vehicle information, it is possible to adjust the luminance of an image to be displayed on the display device 20 in a more appropriate luminance change speed mode on the basis of the surrounding environment of the vehicle M. According to the luminance control in the second control pattern, by suppressing the execution of the second mode or changing the second luminance change speed on the basis of the surrounding environment of the vehicle M at the time of execution, it is possible to perform luminance control more appropriately according to a change in the surrounding environment. With this, it is possible to improve the visual recognition of a user for an image to be displayed.

### MODIFIED EXAMPLE

In the aforementioned embodiment, the example in which the display control device 100 is mounted on the vehicle M has been described, but in addition to this, the display control device 100 can also be applied to an auto interior dimming (AID) technology of various moving bodies such as flying objects and ships. The display control device 100 may also be integrally formed with the display device 20. The display control device 100 may also be mounted on a portable terminal and the like. The portable terminal is, for example, a terminal device that can be carried by a user, such as a smart phone, a tablet terminal, and a wearable terminal having a display function. When the display control device 100 is mounted on the portable terminal, for example, the illuminance sensor 42, the display device 20, and the display control device 100 are integrally formed with the portable terminal. When there are three or more identifications of the luminance change speed mode, the display control device 100 may perform luminance control by transitioning the luminance change speed mode to any one of three or more modes on the basis of the aforementioned surrounding environment, vehicle information, and the like.

According to the embodiment described above, the display control device 100 includes the illuminance acquisition unit 110 that acquires ambient illuminance and the luminance control unit 140 that controls luminance of an image to be displayed on the display device 20 on the basis of the illuminance acquired by the illuminance acquisition unit 110, and when the illuminance acquired by the illuminance acquisition unit 110 satisfies a predetermined condition during the execution of the luminance control in the first mode in which the luminance is changed at the first luminance change speed, the luminance control unit 140 shifts to the second mode in which the luminance is changed at the second luminance change speed faster than the first luminance change speed, and returns to the first mode when a predetermined time has elapsed after shifting to the second mode, so that it is possible to perform luminance control more appropriately.

According to the embodiment, it is possible to perform mode switching under the condition of the ambient illuminance, so that it is possible to change the luminance adjustment speed on the basis of the surrounding environment. Since the second mode returns to the first mode after the predetermined time elapses, it is possible to suppress a user from feeling uncomfortable due to the continuance of the second mode more than necessary. According to the embodiment, it is switched to the second mode when a change in illuminance is continued for the predetermined time or more, so that the mode switching can be automatically performed when necessary, convenience can be secured, and discomfort of a user due to a mode change more than necessary can also be reduced.

According to the embodiment, when the display control device 100 is mounted on a vehicle, shift to the second mode can be suppressed or a state at the time of the shift can be changed on the basis of vehicle information, so that it is possible to perform more appropriate luminance control according to the surrounding environment of the vehicle. According to the embodiment, since the familiarity of user's eyes due to a change from the dark state to the bright state and the familiarity of user's eyes due to a change from the bright state to the dark state are different, the luminance change speed in the second mode can also be changed according to the situation, and an image that is easier to visually recognize can be provided to a user. According to the embodiment, it is possible to shorten time during which an image displayed on the display device is not visible. With this, for example, when a driver of the vehicle confirms the vehicle information through the meter display unit, invisible time is controlled to be shortened, so that an occupant can drive the vehicle more comfortably.

Although a mode for carrying out the present invention has been described using the embodiments, the present invention is not limited to these embodiments and various modifications and substitutions can be made without departing from the spirit of the present invention.

What is claimed is:

1. A display control device comprising a processor configured to function as:
an illuminance acquisition unit configured to acquire ambient illuminance; and
a luminance control unit configured to control luminance of an image to be displayed on a display unit on the basis of the illuminance acquired by the illuminance acquisition unit,
wherein, when the illuminance acquired by the illuminance acquisition unit satisfies a predetermined condition during execution of luminance control in a first mode in which the luminance is changed at a first luminance change speed, the luminance control unit shifts to a second mode in which the luminance is changed at a second luminance change speed faster than the first luminance change speed, and returns to the first mode when a predetermined time has elapsed after shifting to the second mode.

2. The display control device according to claim 1, further comprising:
a bright-dark state determination unit configured to determine an ambient bright-dark state on the basis of the illuminance acquired by the illuminance acquisition unit,
wherein, during the execution of the luminance control in the first mode, when it is determined by the bright-dark state determination unit that the ambient bright-dark state is a dark state and a state in which the illuminance acquired by the illuminance acquisition unit is equal to or more than a first predetermined illuminance has continued for a first predetermined time or more, the luminance control unit shifts to the second mode.

3. The display control device according to claim 2, wherein, during the execution of the luminance control in the first mode, when it is determined by the bright-dark state determination unit that the ambient bright-dark state is a bright state and a state in which the illuminance acquired by the illuminance acquisition unit is equal to or less than a second predetermined illuminance has continued for a second predetermined time or more, the luminance control unit shifts to the second mode.

4. The display control device according to claim 2, wherein, when the bright-dark state is the bright state and a control mode is shifted to the second mode by the luminance control unit, the bright-dark state determination unit shifts the ambient bright-dark state to the dark state, and
when the bright-dark state is the dark state and the control mode is shifted to the second mode by the luminance control unit, the bright-dark state determination unit shifts the ambient bright-dark state to the bright state.

5. The display control device according to claim 3, wherein, during the execution of the luminance control in the first mode, when the bright-dark state is the dark state and the state in which the illuminance is equal to or more than the first predetermined illuminance has continued for the first predetermined time or more or when the bright-dark state is the bright state and the state in which the illuminance is equal to or less than the second predetermined illuminance has continued for the second predetermined time or more, which is different from the first predetermined time, the luminance control unit shifts to the second mode.

6. The display control device according to claim 2, wherein the luminance control unit allows a luminance change speed in the second mode when the bright-dark state is the dark state and the first mode has shifted to the second mode to be different from a luminance change speed when the bright-dark state is the bright state and the first mode has shifted to the second mode.

7. The display control device according to claim 1, wherein the display unit is a display unit mounted on a vehicle, and
the display control device further comprises:
a vehicle information acquisition unit configured to acquire information on the vehicle,
wherein the luminance control unit changes a condition for shifting from the first mode to the second mode on the basis of the vehicle information acquired by the vehicle information acquisition unit.

8. A display control device comprising a processor configured to function as:
an illuminance acquisition unit configured to acquire ambient illuminance; and
a luminance control unit configured to control luminance of an image to be displayed on a display unit on the basis of the illuminance acquired by the illuminance acquisition unit,
wherein the luminance control unit has a first mode in which the luminance is changed at a first luminance change speed, and a second mode in which the luminance is changed at a second luminance change speed faster than the first luminance change speed when a state in which the illuminance acquired by the illuminance acquisition unit is equal to or more than a first predetermined illuminance has continued for a first predetermined time or more or a state in which the illuminance is equal to or less than a second predetermined illuminance has continued for a second predetermined time or more.

9. A display control method implemented by a computer performing the steps of:
acquiring ambient illuminance;
controlling luminance of an image to be displayed on a display unit on the basis of the acquired illuminance;
when the illuminance satisfies a predetermined condition during execution of luminance control in a first mode in which the luminance is changed at a first luminance change speed, shifting to a second mode in which the luminance is changed at a second luminance change speed faster than the first luminance change speed; and
returning to the first mode when a predetermined time has elapsed after shifting to the second mode.

10. A computer readable non-transitory storing medium storing a program causing a computer to perform the steps of:
acquiring ambient illuminance;
controlling luminance of an image to be displayed on a display unit on the basis of the acquired illuminance;
when the illuminance satisfies a predetermined condition during execution of luminance control in a first mode in which the luminance is changed at a first luminance change speed, shifting to a second mode in which the luminance is changed at a second luminance change speed faster than the first luminance change speed; and
returning to the first mode when a predetermined time has elapsed after shifting to the second mode.
